(19) United States
(12) Patent Application Publication
(10) Pub. No.: US 2023/0195529 A1
(43) Pub. Date: Jun. 22, 2023

(54) METHOD, APPARATUS, AND COMPUTER READABLE MEDIUM

(71) Applicant: RAKUTEN MOBILE, INC., Tokyo (JP)

(72) Inventors: Mohit LUTHRA, Singapore (SG); Abhishek SHARMA, Tokyo (JP); Bharath RATHINAM, Tokyo (JP); Puneet DEVADIGA, Tokyo (JP); Jithin CHATHANKANDATH, Tokyo (JP); Seihin SHU, Tokyo (JP)

(21) Appl. No.: 17/644,585

(22) Filed: Dec. 16, 2021

(51) Int. Cl. G06F 9/50

(52) U.S. Cl. CPC G06F 9/505; G06F 9/5077; G06F 2209/505; G06F 2209/501

(57) ABSTRACT

A method includes receiving registration information of an application, extracting resource requirements of the application from the registration information, storing the extracted resource requirements and an identifier of the application in a service catalog, and receiving, from one or more users, a first instruction corresponding to the identifier of the application. In response to the first instruction, application resource requirements are retrieved from the service catalog based on the identifier, the application resource requirements being a portion or all of the extracted resource requirements, a resource manager analyzes a server cluster database based on the application resource requirements and generates a list of server clusters matched to the application resource requirements, and the list of server clusters is output to the one or more users.

### BACKGROUND

Telecom (e.g., wireless, cellular, etc.) and other application workloads are increasingly being transitioned to cloud native applications deployed on data centers that include multiple server clusters. The server clusters are capable of having a variety of resources that are often shared among multiple applications.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram of a communication system, in accordance with some embodiments.

FIG. 2 is a block diagram of a system, in accordance with some embodiments.

FIG. 3 is a flowchart of a method, in accordance with some embodiments.

FIG. 4 depicts application resource requirements, in accordance with some embodiments.

FIG. 5 depicts an inventory data model, in accordance with some embodiments.

FIG. 6 depicts a server cluster recommendation payload, in accordance with some embodiments.

FIG. 7 is a schematic view of a system, in accordance with some embodiments.

### DETAILED DESCRIPTION

The following disclosure provides different embodiments, or examples, for implementing features of the provided subject matter. Specific examples of components, materials, values, steps, arrangements, or the like, are described below to simplify the present disclosure. These are, of course, merely examples and are not limiting. Other components, materials, values, steps, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In various embodiments, a method, apparatus, and computer readable medium are directed to automatically extracting resource requirements of an application from registration information, analyzing a server cluster database based on the application resource requirements, and generating a list of server clusters matched to the application resource requirements.

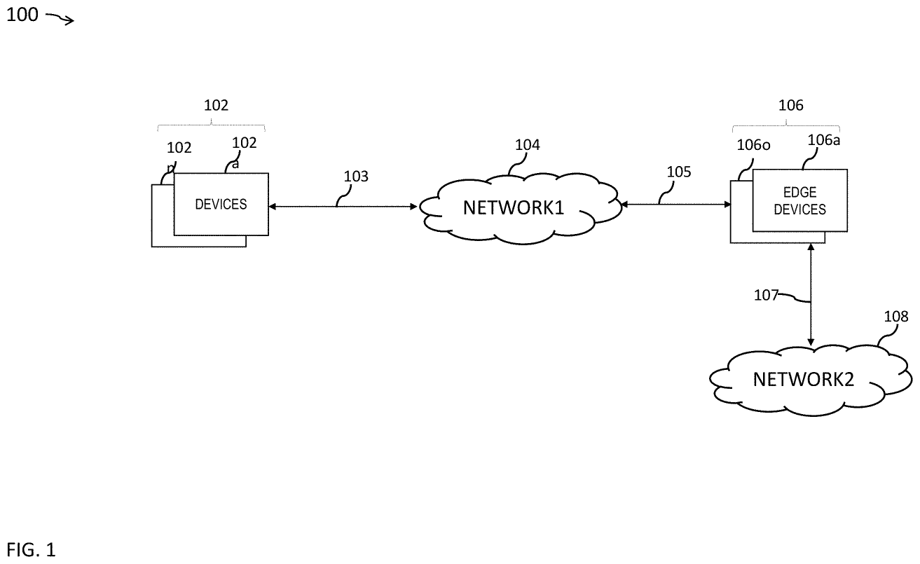

FIG. 1 is a block diagram of a communication system 100 (hereinafter referred to as “system 100”), in accordance with some embodiments.

System 100 includes a set of devices 102 coupled to a network 104 by a link 103, and network 104 is further coupled to a set of edge devices 106 by a link 105. System 100 further includes a network 108 coupled to the set of edge devices 106 by a link 107. The set of edge devices 106 and the set of devices 102 are coupled to each other by network 104.

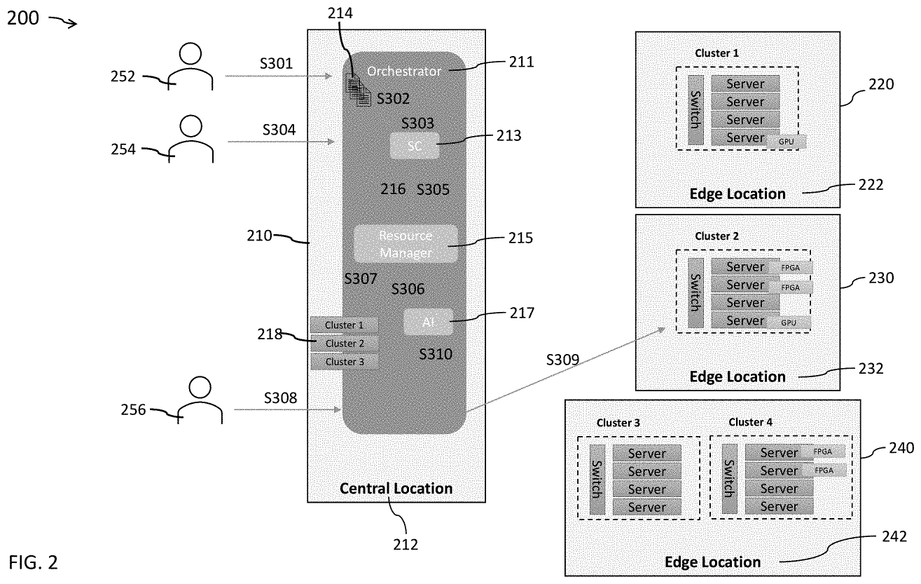

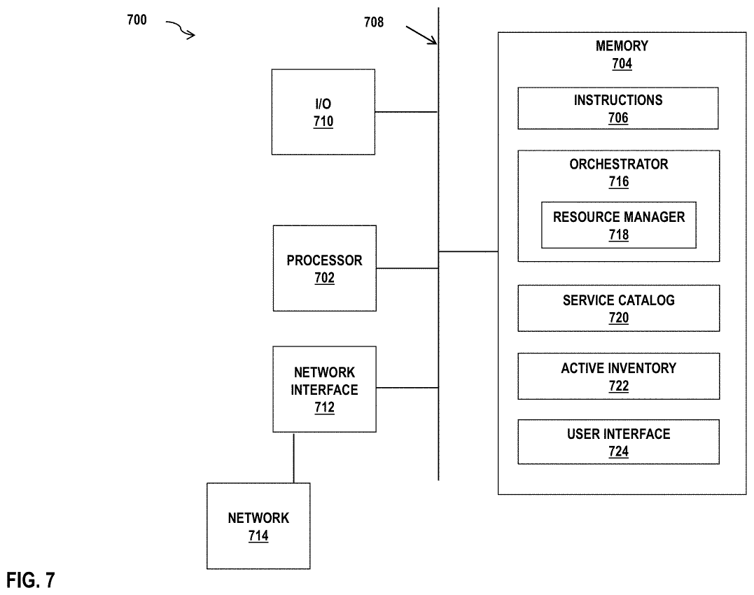

The set of devices 102 includes devices 102a, 102b, . . . 102n, where n is an integer corresponding to a number of devices in the set of devices 102. In some embodiments, one or more devices in the set of devices 102 corresponds to a computing device, a computing system or a server. In some embodiments, a device 210 (FIG. 2) corresponds to one or more of devices 102a, 102b, . . . 102n of the set of devices 102. In some embodiments, a system 700 (FIG. 7) is an embodiment of one or more of devices 102a, 102b, . . . 102n of the set of devices 102. In some embodiments, the set of devices 102 corresponds to a server farm. In some embodiments, the set of devices 102 corresponds to a data center.

In some embodiments, one or more of devices 102a, 102b, . . . 102n of the set of devices 102 is a type of mobile terminal, fixed terminal, or portable terminal including a desktop computer, laptop computer, notebook computer, netbook computer, tablet computer, wearable circuitry, mobile handset, server, gaming console, or combination thereof. In some embodiments, one or more of devices 102a, 102b, . . . 102n of the set of devices 102 includes a display by which a user interface is displayed.

Other configurations, different types of devices or other number of sets in the set of devices 102 are within the scope of the present disclosure.

The set of edge devices 106 includes at least edge devices 106a, 106b, . . . 106o, where o is an integer corresponding to a number of edge devices in the set of edge devices 106. In some embodiments, integer o is greater than integer n. In some embodiments, integer o is greater than integer n by at least a factor of 100. In some embodiments, the integer o is greater than integer n by at least a factor of 1000. Other factors are within the scope of the present disclosure.

In some embodiments, one or more edge devices in the set of edge devices 106 corresponds to a computing device, computing system, or a server. In some embodiments, the set of edge devices 106 corresponds to one or more server clusters. In some embodiments, the set of edge devices 106 corresponds to data centers 220, 230, and 240 (FIG. 2). In some embodiments, system 700 (FIG. 7) is an embodiment of one or more edge devices 106a, 106b, . . . 106o of the set of edge devices 106.

Other configurations, different types of edge devices or other number of sets in the set of edge devices 106 are within the scope of the present disclosure.

In some embodiments, at least one of network 104 or 108 corresponds to a wired or wireless network. In some embodiments, at least one of network 104 or 108 corresponds to a local area network (LAN). In some embodiments, at least one of network 104 or 108 corresponds to a wide area network (WAN). In some embodiments, at least one of network 104 or 108 corresponds to a metropolitan area network (MAN). In some embodiments, at least one of network 104 or 108 corresponds to an internet area network (IAN), a campus area network (CAN) or a virtual private networks (VPN). In some embodiments, at least one of network 104 or 108 corresponds to the Internet.

Other configurations, number of networks or different types of network in at least network 104 or 108 are within the scope of the present disclosure.

In some embodiments, at least one of link 103, 105, or 107 is a wired link. In some embodiments, at least one of link 103, 105, or 107 is a wireless link. In some embodiments, at least one of link 103, 105, or 107 corresponds to any transmission medium type; e.g. fiber optic cabling, any wired cabling, and any wireless link type(s). In some embodiments, at least one of link 103, 105, or 107 corresponds to shielded, twisted-pair cabling, copper cabling, fiber optic cabling, and/or encrypted data links.

In some embodiments, at least one of link 103, 105, or 107 is based on different technologies, such as code division multiple access (CDMA), wideband CDMA (WCDMA), time division multiple access (TDMA), frequency division multiple access (FDMA), Orthogonal Frequency Division Multiplexing (OFDM), time division duplexing (TDD), frequency division duplexing (FDD), Bluetooth, Infrared (IR), or the like, or other protocols that may be used in a wireless communications network or a wired data communications network. Accordingly, the exemplary illustrations provided herein are not intended to limit the embodiments of the disclosure and are merely to aid in the description of aspects of the embodiments of the disclosure.

Other configurations or number of links in at least one of link 103, 105, or 107 are within the scope of the present disclosure. For example, while FIG. 1 shows a single link for each of links 103, 105, and 107, one or more of links 103, 105, or 107 include a plurality of links.

Other configurations or number of elements in system 100 are within the scope of the present disclosure.

FIG. 2 is a block diagram of a system 200, in accordance with some embodiments. FIG. 2 is simplified for the purpose of illustration.

System 200 is an embodiment of system 100, and similar detailed description is omitted.

System 200 includes a device 210 connected to data centers 220, 230, and 240. Device 210 is located at a location 212, data center 220 is located at an edge location 222, data center 230 is located at an edge location 232, and data center 240 is located at an edge location 242. In the embodiment depicted in FIG. 2, location 212 is different from each of edge locations 222, 232, and 242, and edge locations 222, 232, and 242 are different from each other. In some embodiments, location 212 is at a same location as one or more of edge locations 222, 232, or 242, and/or two or more of edge locations 222, 232, or 242 are at a same location. In some embodiments, location 212 is referred to as a central location.

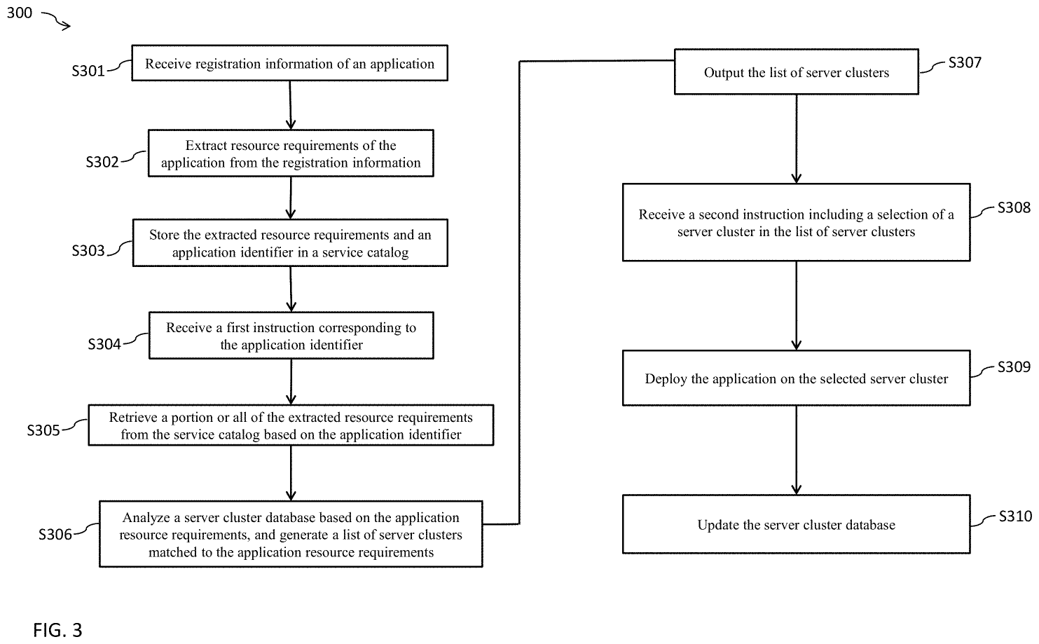

System 200 shows a series of steps or operations (e.g., S301, S302, S303, S304, S305, S306, S307, S308, S309, and S310), performed by system 200, and are described in FIG. 3 as a method 300.

Device 210 is an embodiment of one or more devices in the set of devices 102 of FIG. 1, and similar detailed description is omitted. Each of data centers 220, 230, and 240 is an embodiment of one or more edge devices in the set of edge devices 106 of FIG. 1, and similar detailed description is omitted. Device 210 is coupled to each of data centers 220, 230, and 240 by a network (not shown), such as network 104.

Each of data centers 220, 230, and 240 is a computing service facility including multiple servers arranged as server clusters. A server cluster is a logical entity of a group of servers, e.g., a group of servers collectively controlled to provide backup or other capabilities. In the embodiment depicted in FIG. 2, data center 220 includes a single server cluster, Cluster 1, data center 230 includes a single server cluster, Cluster 2, and data center 240 includes Clusters 3 and 4. In some embodiments, one or more of data centers 220, 230, or 240 includes a number of server clusters greater than the numbers depicted in FIG. 2. In some embodiments, one or more of data centers 220, 230, or 240 includes tens of server clusters. In some embodiments, one or more of data centers 220, 230, or 240 includes hundreds or thousands of server clusters.

While FIG. 2 shows system 200 including three data centers, 220, 230, and 240, other numbers of data centers are within the scope of the present disclosure. In some embodiments, system 200 includes tens of data centers. In some embodiments, system 200 includes hundreds or thousands of data centers. In some embodiments, data centers 220, 230, and 240 and the corresponding server clusters are referred to as an ecosystem.

Device 210 is configured to receive one or more software applications from one or more users 252, 254, and 256, and automatically deploy the one or more software applications on corresponding one or more server clusters of data centers 220, 230, and 240. Data centers 220, 230, and 240 are configured to store, execute and provide access to the one or more deployed applications by network 104 and 108 to other devices (including the set of devices 102).

Device 210 includes an orchestrator 211. Orchestrator 211 is one or more sets of instructions, e.g., program code, configured to automatically provision, orchestrate, manage, and deploy the one or more software applications on data centers 220, 230, and 240. Orchestrator 211 is configured to automatically extract resource requirements 214 of an application from registration information, analyze a server cluster database 217 based on some or all of resource requirements 214, generate a list 218 of server clusters matched to the some or all of resource requirements 214, and deploy the application in response to a selection of a server cluster from list 218.

In some embodiments, orchestrator 211 of device 210 is the sole orchestrator of a particular ecosystem, e.g., data centers 220, 230, and 240. In some embodiments, orchestrator 211 of device 210 is one of multiple orchestrators 211 of corresponding multiple devices 210 of a particular ecosystem.

Orchestrator 211 includes a user interface capable of receiving user instructions from the one or more users 252, 254, and 256, the instructions including user 252 providing registration information and uploading the corresponding files of a software application, also referred to as a bundle package or package file in some embodiments, to device 210. In some embodiments, users 252, 254, and 256 are separate users. In some embodiments, two or more of users 252, 254, or 256 are a same user.

Orchestrator 211 is configured to automatically extract resource requirements 214 of the software application from the registration information, e.g., by parsing the registration information received from user 252, and storing the extracted resource requirements 214 in a service catalog 213. Resource requirements 214 include an identifier of the software application. In some embodiments, resource requirements 214 include information provided by user 252 in the user instructions, e.g., one or more preferences directed to a geographic location or data center type.

Resource requirements 214 include one or more of a memory requirement, a storage requirement, a central processing unit (CPU) requirement, a supplemental processing requirement, an input-output (I/O) or other hardware interface requirement, a software requirement, a user-specified requirement, or other technical requirement suitable for storing and/or executing the software application.

In some embodiments, a memory requirement includes one or more of a memory size, type, configuration, or other criteria suitable for defining computer memory capabilities. A storage requirement includes one or more of a storage type, e.g., hard disk drive (HDD) or solid state drive (SSD), size, configuration, or other criteria suitable for defining data storage capabilities.

In some embodiments, a CPU requirement includes one or more of a number of physical or virtual processor cores, processor speed, or other criteria suitable for defining general computer processing capabilities. A supplemental processing requirement includes one or more application-specific computational capability requirements, e.g., a graphics processing unit (GPU) requirement, a field-programmable gate array (FPGA) requirement, or other capability provided by hardware supplemental to general processing hardware.

In some embodiments, an I/O or other hardware interface requirement includes one or more of a network interface card (NIC), a single root I/O virtualization (SRIOV), open virtual switch (OVS), or other criteria suitable for defining interfacing capabilities.

In some embodiments, a software requirement includes one or more of an operating system (OS) requirement, e.g., an OS type and/or version, an application programming interface (API) requirement, or other supplemental software requirement.

In some embodiments, a user-specified requirement includes one or more of a geographic location or region, e.g., a country, including one or more of data centers 220, 230, or 240, a data center type such as a group center (GC) type corresponding to far edge data centers, a regional data center (RDC) type corresponding to near edge data centers, or a central data center (CDC) type corresponding to centrally located data centers, or other criteria provided by a user suitable for specifying a data center or server cluster technical requirement.

In some embodiments, an other technical requirement includes one or more of a resource pool (Rpool) requirement, a tag identifying an application type of the software application, or other application-specific criteria suitable for identifying server cluster compatibility.

In some embodiments, resource requirements 214 correspond to the software application being an information technology (IT) application configured to execute on data centers 220, 230, and 240 corresponding to one or more public, general-application cloud environments. In some embodiments, resource requirements 214 include one or more GPU requirements corresponding to an IT application.

In some embodiments, resource requirements 214 correspond to the software application being a telecommunication (Telco) application configured to execute on data centers 220, 230, and 240 corresponding to one or more private, application-specific environments, e.g., a virtual radio access network (vRAN). In some embodiments, resource requirements 214 include one or more FPGA and/or hardware interface requirements corresponding to a Telco application.

Service catalog 213 is one or more storage devices configured to store data corresponding to application software and clients of device 210, e.g., users 252, 254, and/or 256. Service catalog 213 includes resource requirements 214 and other data suitable for deploying and maintaining various software applications on the ecosystem including device 210.

In some embodiments, service catalog 213 includes a database. In the embodiment depicted in FIG. 2, service catalog 213 is located in device 210. In some embodiments, service catalog 213 is located partially or entirely external to device 210, e.g., on another device 102 or on an edge device 106.

In addition to storing resource requirements 214 in service catalog 213, orchestrator 211 is configured to automatically retrieve some or all of resource requirements 214 from service catalog 213 responsive to instructions received from user 254, the instructions including an identifier of the software application. In some embodiments, user 254 is the same as user 252 and the instructions are included in the registration and application uploading instructions. In some embodiments, the instructions are separate from the registration and application uploading instructions, e.g., received later in time and/or from user 254 different from user 252.

Orchestrator 211 is configured to retrieve the some or all of resource requirements 214 from service catalog 213 as application resource requirements 216. In some embodiments, application resource requirements 216 are a subset of resource requirements 214 based on user information received from user 254. In some embodiments, application resource requirements 216 are a subset of resource requirements 214 based on orchestrator 211 performing an analysis, e.g., a parsing operation, on resource requirements 214. In some embodiments, application resource requirements 216 are an entirety of resource requirements 214.

Orchestrator 211 is configured to provide application resource requirements 216 to a resource manager 215. Resource manager 215 is one or more sets of instructions, e.g., program code, configured to automatically maintain server cluster database 217, also referred to as active inventory 217 in some embodiments. In the embodiment depicted in FIG. 2, resource manager 215 is a component of orchestrator 211. In some embodiments, resource manager 215 is separate from orchestrator 211.

Server cluster database 217 is one or more storage devices configured to store data corresponding to resource capabilities of the server clusters of data centers 220, 230, and 240. The resource capabilities include at least capabilities corresponding to application resource requirements 216. The stored data represents hardware and software capacities of each server cluster of data centers 220, 230, and 240, and available subsets of the various capacities based on server clusters being used by deployed applications and/or reserved for potential future application deployments. Resource manager 215 is configured to automatically update server cluster database 217 based on software deployments and/or reservations.

In the embodiment depicted in FIG. 2, server cluster database 217 is a database. In some embodiments, server cluster database 217 is another type of data storage, e.g., one or more data files, configured to store the resource capabilities data.

In the embodiment depicted in FIG. 2, server cluster database 217 is located in device 210. In some embodiments, server cluster database 217 is located partially or entirely external to device 210, e.g., on another device 102 or on an edge device 106.

Resource manager 215 is configured to analyze server cluster database 217 based on application resource requirements 216, and generate list 218 of recommended server clusters matched to application resource requirements 216. Resource manager 215 includes one or more algorithms configured to identify sets of server cluster capabilities stored in server cluster database 217 that match the resource requirements specified in application resource requirements 216.

Resource manager 215 generates list 218 including a number of server clusters corresponding to the sets identified by matching data in server cluster database 217 to application resource requirements 216. In some embodiments, resource manager 215 assigns a rank to one or more server clusters and includes the rank information in list 218.

In the embodiment depicted in FIG. 2, resource manager 215 generates list 218 including the number of server clusters equal to three (represented as Clusters 1, 2, and 3). In some embodiments, resource manager 215 generates list 218 including the number of server clusters greater or fewer than three. In some embodiments, resource manager 215 generates list 218 including the number of server clusters included in user information received from user 254.

Resource manager 215 is configured to output list 218 to user 256. In some embodiments, user 256 and user 254 are the same. Resource manager 215 is configured to receive an indication from user 256 of a selection of a server cluster from list 218. In response to receiving the selection, resource manager 215 is configured to deploy the software application on the selected server cluster.

In some embodiments, after deploying the software application, resource manager 215 is configured to update server cluster database 217 to reflect the change in hardware and software capacities of the server clusters of data centers 220, 230, and 240 corresponding to the software application deployment.

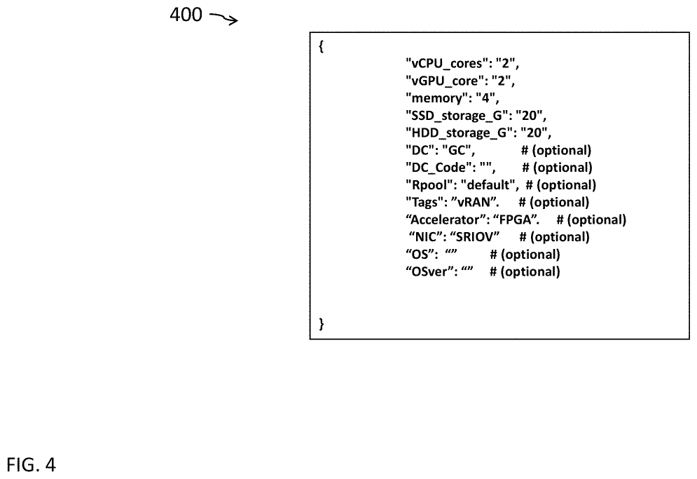

FIG. 4 depicts application resource requirements 400, in accordance with some embodiments. Application resource requirements 400 is a non-limiting example of application resource requirements 216.

In the non-limiting example depicted in FIG. 4, application resource requirements 400 includes requirements of 2 virtual CPU cores, 2 virtual GPU cores, 4 memory banks, 20 gigabytes each of SSD and HDD storage, a GC data center, no specified resource pool requirements, a vRAN tag, a FPGA accelerator, and a SRIOV NIC.

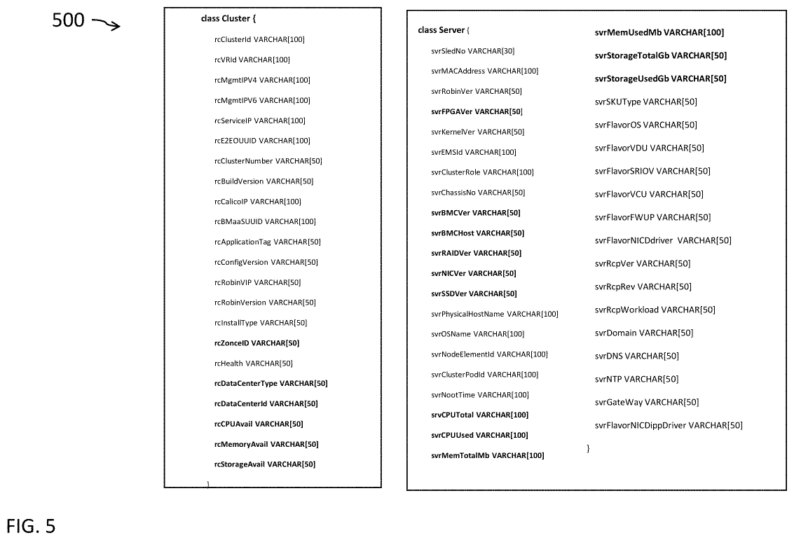

FIG. 5 depicts an inventory data model 500, in accordance with some embodiments. Inventory data model 500 is a non-limiting example of data included in server cluster database 217.

In the non-limiting example depicted in FIG. 5, inventory data model 500 includes parameters corresponding to a cluster data model (on left) and a server data model (on right). Example cluster data model information includes a unique cluster identifier Cluster ID, a platform layer identifier rcRobinVerion corresponding to the platform version deployed on the cluster, and a data center type rcDataCenterType identifying data center including the cluster as one of GC, RDC, or CDC. Example server data model information includes svrFPGAVer identifying an FPGS version, svrCPUTotal identifying a total number of CPUs in the server, and svrCPUUsed identifying a number of CPUs used and/or reserved by previously and/or potentially deployed applications.

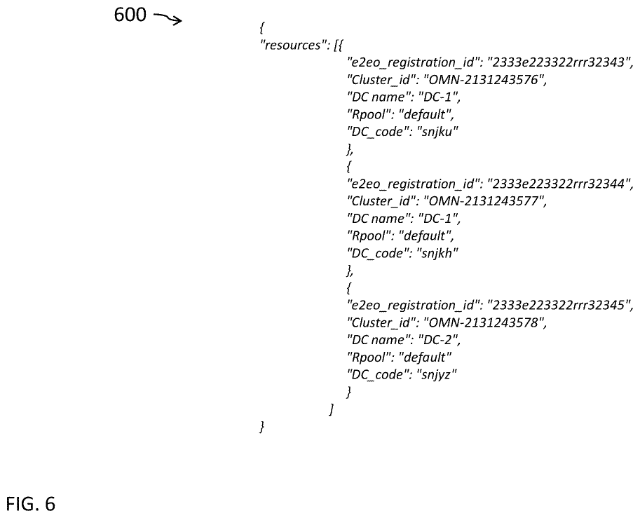

FIG. 6 depicts a server cluster recommendation payload 600, in accordance with some embodiments. In some embodiments, server cluster recommendation payload 600 is a non-limiting example of list 218. In some embodiments, server cluster recommendation payload 600 is a non-limiting example of a data model used to generate list 218.

In the non-limiting example depicted in FIG. 6, server cluster recommendation payload 600 includes data sets corresponding to three server clusters. Each data set includes e2eo_registration_id, a unique ID registered to orchestrator 211, Cluster_id, a unique ID generated by resource manager 215, DC Name, a name of the data center including the server cluster, Rpool, a resource pool assigned from the server cluster, and DC_code, a unique data center identifier.

By the configuration discussed above, device 210 including orchestrator 211 is configured to automatically extract resource requirements of an application from registration information, analyze a server cluster database based on the application resource requirements, and generate a list of server clusters matched to the application resource requirements, thereby improving operation of system 200 compared to other approaches.

FIG. 3 is a flowchart of method 300, in accordance with some embodiments.

In some embodiments, method 300 is a method of extracting resource requirements of an application from registration information, analyzing a server cluster database based on the application resource requirements, and generating a list of server clusters matched to the application resource requirements. In some embodiments, at least portions of method 300 are performed by orchestrator 211.

In some embodiments, FIG. 3 is a flowchart of a method of operating system 100 of FIG. 1 or system 200 of FIG. 2, and similar detailed description is therefore omitted. It is understood that additional operations may be performed before, during, between, and/or after the operations of method 300 depicted in FIG. 3, and that some other operations may only be briefly described herein. In some embodiments, other orders of operations of method 300 are within the scope of the present disclosure. In some embodiments, one or more operations of method 300 are not performed.

Method 300 includes exemplary operations, but the operations are not necessarily performed in the order shown. Operations may be added, replaced, changed order, and/or eliminated as appropriate, in accordance with the spirit and scope of disclosed embodiments.

In operation S301 of method 300, registration information of an application is received by orchestrator 211. In some embodiments, the registration information is received from user 252.

In operation S302 of method 300, resource requirements 214 of the application are extracted from the registration information. In some embodiments, extracting resource requirements 214 includes parsing the registration information.

In operation S303 of method 300, the extracted resource requirements 214 and an application identifier are stored in service catalog 213. In some embodiments, the application identifier is received from user 252.

In operation S304 of method 300, a first instruction corresponding to the application identifier is received by orchestrator 211. Receiving the first instruction includes receiving the first instruction from user 254.

In operation S305 of method 300, in response to the first instruction, a portion or all of the extracted resource requirements 214 are retrieved from service catalog 213 based on the application identifier. Retrieving the some or all of the extracted resource requirements 214 corresponds to retrieving application resource requirements 216.

In operation S306 of method 300, server cluster database 217 is analyzed by resource manager 215 based on application resource requirements 216, and list 218 of server clusters matched to application resource requirements 216 is generated by orchestrator 211.

In operation S307 of method 300, list 218 is output by orchestrator 211. In some embodiments, outputting list 218 includes outputting list 218 to user 256.

In operation S308 of method 300, a second instruction is received by orchestrator 211 including a selection of a server cluster in list 218. In some embodiments, receiving the second instruction includes receiving the second instruction from user 256.

In operation S309 of method 300, in response to the second instruction, the application is deployed by orchestrator 211 on the selected server cluster.

In operation S310 of method 300, server cluster database 217 is updated by resource manager 215 based on deployment of the selected application.

In some embodiments, one or more of operations S310-S310 are repeated, e.g., corresponding to various operations being performed over a span of time during which data in server cluster database 217 is repeatedly updated such that results of the analysis performed in operation S306 are potentially affected.

FIG. 7 is a schematic view of a system 700, in accordance with some embodiments.

In some embodiments, system 700 is an embodiment of device 210 of FIG. 2, and similar detailed description is therefore omitted.

In some embodiments, system 700 is an embodiment of one or more elements in device 210, and similar detailed description is therefore omitted. For example, in some embodiments, system 700 is an embodiment of one or more of orchestrator 211 or resource manager 215, and similar detailed description is therefore omitted.

In some embodiments, system 700 is an embodiment of one or more devices 102 in FIG. 1, and similar detailed description is therefore omitted.

In some embodiments, system 700 is an embodiment of one or more edge devices 106 in FIG. 1 or one or more servers of data centers 220, 230, or 240, and similar detailed description is therefore omitted.

In some embodiments, system 700 is configured to perform one or more operations of method 300.

System 700 includes a hardware processor 702 and a non-transitory, computer readable storage medium 704 (e.g., memory 704) encoded with, i.e., storing, the computer program code 706, i.e., a set of executable instructions 706. Computer readable storage medium 704 is configured to interface with at least one of devices 102 in FIG. 1, edge devices 106 in FIG. 1, device 210, or one or more servers of data centers 220, 230, or 240.

Processor 702 is electrically coupled to computer readable storage medium 704 by a bus 708. Processor 702 is also electrically coupled to an I/O interface 710 by bus 708. A network interface 712 is also electrically connected to processor 702 by bus 708. Network interface 712 is connected to a network 714, so that processor 702 and computer readable storage medium 704 are capable of connecting to external elements by network 714. Processor 702 is configured to execute computer program code 706 encoded in computer readable storage medium 704 in order to cause system 700 to be usable for performing a portion or all of the operations as described in method 300. In some embodiments, network 714 is not part of system 700. In some embodiments, network 714 is an embodiment of network 104 or 108 of FIG. 1.

In some embodiments, processor 702 is a central processing unit (CPU), a multi-processor, a distributed processing read circuit, an application specific integrated circuit (ASIC), and/or a suitable processing unit.

In some embodiments, computer readable storage medium 704 is an electronic, magnetic, optical, electromagnetic, infrared, and/or a semiconductor read circuit (or apparatus or device). For example, computer readable storage medium 704 includes a semiconductor or solid-state memory, a magnetic tape, a removable computer diskette, a random access memory (RAM), a read-only memory (ROM), a rigid magnetic disk, and/or an optical disk. In some embodiments using optical disks, computer readable storage medium 704 includes a compact disk-read only memory (CD-ROM), a compact disk-read/write (CD-R/W), and/or a digital video disc (DVD).

In some embodiments, forms of computer-readable media include, for example, a floppy disk, a flexible disk, a hard disk, a magnetic tape, another magnetic medium, a CD-ROM, CDRW, DVD, another optical medium, punch cards, paper tape, optical mark sheets, another physical medium with patterns of holes or other optically recognizable indicia, a RAM, a PROM, an EPROM, a FLASH-EPROM, an EEPROM, a flash memory, another memory chip or cartridge, or another medium from which a computer can read. The term computer-readable storage medium is used herein to refer to a computer-readable medium.

In some embodiments, storage medium 704 stores computer program code 706 configured to cause system 700 to perform one or more operations of method 300. In some embodiments, storage medium 704 also stores information used for performing method 300 as well as information generated during performing method 300, such as orchestrator 716, resource manager 718, service catalog 720, active inventory 722, user interface 724, and/or a set of executable instructions to perform one or more operations of method 300.

In some embodiments, storage medium 704 stores instructions (e.g., computer program code 706) for interfacing with at least devices 102 in FIG. 1, edge devices 106 in FIG. 1, device 210, orchestrator 211, resource manager 215, or one or more of data centers 220, 230, or 240. The instructions (e.g., computer program code 706) enable processor 702 to generate instructions readable by at least devices 102 in FIG. 1, edge devices 106 in FIG. 1, device 210, orchestrator 211, resource manager 215, or one or more of data centers 220, 230, or 240 to effectively implement one or more operations of method 300 during operation of device 210.

System 700 includes I/O interface 710. I/O interface 710 is coupled to external circuitry. In some embodiments, I/O interface 710 includes a keyboard, keypad, mouse, trackball, trackpad, and/or cursor direction keys for communicating information and commands to processor 702.

System 700 also includes network interface 712 coupled to the processor 702. Network interface 712 allows system 700 to communicate with network 714, to which one or more other computer read circuits are connected. Network interface 712 includes wireless network interfaces such as BLUETOOTH, WIFI, WIMAX, GPRS, or WCDMA; or wired network interface such as ETHERNET, USB, or IEEE-884. In some embodiments, method 300 is implemented in two or more systems 700, and information such as orchestrator 716, resource manager 718, service catalog 720, active inventory 722, and user interface 724 are exchanged between different systems 700 by network 714.

System 700 is configured to receive information related to orchestrator 716 through I/O interface 710 or network interface 712. The information is transferred to processor 702 by bus 708, and is then stored in computer readable medium 704 as orchestrator 716. In some embodiments, orchestrator 716 including resource manager 718 corresponds to orchestrator 211 including resource manager 215, and similar detailed description is therefore omitted. System 700 is configured to receive information related to orchestrator 716 through I/O interface 710 or network interface 712. In some embodiments, the information is stored in computer readable medium 704 as service catalog 720. In some embodiments, service catalog 720 corresponds to service catalog 213, and similar detailed description is therefore omitted. System 700 is configured to receive information related to active inventory 722 through I/O interface 710 or network interface 712. The information is stored in computer readable medium 704 as active inventory 722. In some embodiments, active inventory 722 corresponds to server cluster database 217, and similar detailed description is therefore omitted. System 700 is configured to receive information related to a user interface through I/O interface 710 or network interface 712. The information is stored in computer readable medium 704 as user interface 724.

In some embodiments, method 300 is implemented as a standalone software application for execution by a processor. In some embodiments, method 300 is implemented as corresponding software applications for execution by one or more processors. In some embodiments, method 300 is implemented as a software application that is a part of an additional software application. In some embodiments, method 300 is implemented as a plug-in to a software application.

In some embodiments, method 300 is implemented as a software application that is a portion of an orchestrator tool. In some embodiments, method 300 is implemented as a software application that is used by an orchestrator tool. In some embodiments, one or more of the operations of method 300 is not performed.

It will be readily seen by one of ordinary skill in the art that one or more of the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

One aspect of this description relates to a method executed by a processor. In some embodiments, the method includes receiving registration information of an application, extracting resource requirements of the application from the registration information, storing the extracted resource requirements and an identifier of the application in a service catalog, receiving, from one or more users, a first instruction corresponding to the identifier of the application. In response to the first instruction, application resource requirements are retrieved from the service catalog based on the identifier, the application resource requirements being a portion or all of the extracted resource requirements, a resource manager analyzes a server cluster database based on the application resource requirements and generates a list of server clusters matched to the application resource requirements, and the list of server clusters is output to the one or more users.

Another aspect of this description relates to an apparatus. In some embodiments, the apparatus includes a memory having non-transitory instructions stored, and a processor coupled to the memory, and being configured to execute the instructions, thereby causing the apparatus to store registration information of an application, parse resource requirements of the application from the registration information, store the extracted resource requirements and an application identifier in a service catalog, receive, from the user interface, a first instruction comprising the application identifier, and in response to the first instruction, retrieve first application resource requirements from the service catalog based on the application identifier, the first application resource requirements being a first portion or all of the extracted resource requirements, analyze a server cluster database based on the first application resource requirements, and generate a first list of server clusters matched to the application resource requirements, and output the first list of server clusters to the user interface.

Still another aspect of this description relates to a computer-readable medium. In some embodiments, the computer-readable medium includes instructions executable by a controller of a user equipment to cause the controller to perform operations including extracting resource requirements of an application from registration information stored on the user equipment, storing the extracted resource requirements and an application identifier in a service catalog, receiving, from a user of the user equipment, a first input comprising the application identifier, and in response to receiving the first input, using the application identifier to retrieve application resource requirements from the service catalog, the application resource requirements being a portion or all of the extracted resource requirements, matching the application resource requirements to resources of server clusters in a server cluster database, thereby generating a set of server clusters from the server cluster database, outputting a list of the set of server clusters from the user equipment, receiving, from the user of the user equipment, a second input including a selection of a server cluster from the list, and deploying the application on the selected server cluster.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method executed by a processor, the method comprising:
receiving registration information of an application;
extracting resource requirements of the application from the registration information;
storing the extracted resource requirements and an identifier of the application in a service catalog;
receiving, from one or more users, a first instruction corresponding to the identifier of the application; and
in response to receiving the first instruction:
retrieving application resource requirements from the service catalog based on the identifier, the application resource requirements being a portion or all of the extracted resource requirements;
using a resource manager to analyze a server cluster database based on the application resource requirements, and generate a list of server clusters matched to the application resource requirements; and
outputting the list of server clusters to the one or more users.

2. The method of claim 1, wherein the extracted resource requirements comprise one or more of a memory requirement, a storage requirement, a central processing unit (CPU) requirement, a graphics processing unit (GPU) requirement, a field-programmable gate array (FPGA) requirement, or a geographic location requirement.

3. The method of claim 1, wherein extracting the resource requirements of the application comprises parsing the registration information.

4. The method of claim 1, further comprising:
using the resource manager to update the server cluster database,
wherein analyzing the server cluster database is based on the updated server cluster database.

5. The method of claim 1, wherein generating the list of server clusters comprises assigning a rank to a server cluster.

6. The method of claim 1, wherein outputting the list of server clusters comprises outputting the list comprising three or fewer server clusters.

7. The method of claim 1, further comprising:
receiving, from the one or more users, a second instruction comprising a selection of a server cluster in the list of server clusters; and
in response to receiving the second instruction, deploying the application on the selected server cluster.

8. An apparatus, comprising:
a user interface;
a memory having non-transitory instructions stored; and
a processor coupled to the memory, and being configured to execute the instructions, thereby causing the apparatus to:
store registration information of an application;
parse resource requirements of the application from the registration information;
store the resource requirements and an application identifier in a service catalog;
receive, from the user interface, a first instruction comprising the application identifier; and
in response to receiving the first instruction:
retrieve first application resource requirements from the service catalog based on the application identifier, the first application resource requirements being a first portion or all of the resource requirements;
analyze a server cluster database based on the first application resource requirements, and generate a first list of server clusters matched to the application resource requirements; and
output the first list of server clusters to the user interface.

9. The apparatus of claim 8, wherein the resource requirements comprise one or more of a memory requirement, a storage requirement, a central processing unit (CPU) requirement, a graphics processing unit (GPU) requirement, a field-programmable gate array (FPGA) requirement, or a geographic location requirement.

10. The apparatus of claim 8, wherein the instructions further cause the apparatus to:
update the server cluster database;
receive, from the user interface, a second instruction comprising the application identifier; and
in response to receiving the second instruction:
retrieve second application resource requirements from the service catalog based on the application identifier, the second application resource requirements being a second portion or all of the resource requirements;
analyze the updated server cluster database based on the second application resource requirements, and generate a second list of server clusters matched to the application resource requirements; and
output the second list of server clusters to the user interface.

11. The apparatus of claim 10, wherein the instructions that cause the apparatus to update the server cluster database comprise instructions that cause the apparatus to update usage information of a server cluster in the server cluster database.

12. The apparatus of claim 8, wherein the list of server clusters comprises a server cluster rank.

13. The apparatus of claim 8, wherein the list of server clusters comprises three or fewer server clusters.

14. The apparatus of claim 8, wherein the instructions further cause the apparatus to:
receive, from the user interface, a second instruction comprising a selection of a server cluster in the list of server clusters; and
in response to receiving the second instruction, deploy the application on the selected server cluster.

15. A computer-readable medium including instructions executable by a controller of a user equipment to cause the controller to perform operations comprising:
extracting resource requirements of an application from registration information stored on the user equipment;
storing the extracted resource requirements and an application identifier in a service catalog;
receiving, from a user of the user equipment, a first input comprising the application identifier; and
in response to receiving the first input:
using the application identifier to retrieve application resource requirements from the service catalog, the application resource requirements being a portion or all of the extracted resource requirements;
matching the application resource requirements to resources of server clusters in a server cluster database, thereby generating a set of server clusters from the server cluster database,
outputting a list of the set of server clusters from the user equipment;
receiving, from the user of the user equipment, a second input comprising a selection of a server cluster from the list; and
deploying the application on the selected server cluster.

16. The computer-readable medium of claim 15, wherein the instructions are executable by the controller of the user equipment to cause the controller to perform the operations further comprising storing the registration information on the user equipment.

17. The computer-readable medium of claim 15, wherein the extracted resource requirements comprise one or more of a memory requirement, a storage requirement, a central processing unit (CPU) requirement, a graphics processing unit (GPU) requirement, a field-programmable gate array (FPGA) requirement, or a geographic location requirement.

18. The computer-readable medium of claim 15, wherein extracting the resource requirements of the application comprises parsing the stored registration information.

19. The computer-readable medium of claim 15, wherein the instructions are executable by the controller of the user equipment to cause the controller to perform the operations further comprising updating the resources of the server clusters in the server cluster database.

20. The computer-readable medium of claim 15, wherein outputting the list of the set of server clusters from the user equipment comprises associating a rank with each of three server clusters.
